(19) United States
(12) Patent Application Publication
(10) Pub. No.: US 2016/0304658 A1
(43) Pub. Date: Oct. 20, 2016

(54) METHOD FOR PRODUCING PREPOLYMERS WITH AN ISOCYANATE TERMINATION FOR PRODUCING POLYURETHANES

(71) Applicant: MERYLITHE, Mery (FR)

(72) Inventors: Hervé TRENTESAUX, Paris (FR); Laure RAMBAHINIARISON, Le Bourget Du Lac (FR); Rémi BUFFARD, Saint Jeoire Prieure (FR); Jean-Pierre PASCAULT, Villeurbanne (FR)

(73) Assignee: MERYLITHE, Mery (FR)

(21) Appl. No.: 15/101,681

(22) PCT Filed: Dec. 5, 2014
(86) PCT No.: PCT/EP2014/076790

§ 371 Date: Jun. 3, 2016

(30) Foreign Application Priority Data
Dec. 5, 2013 (FR) 1362130

(51) Int. Cl. C08G 18/12; C08G 18/38; C08G 18/76

(52) U.S. Cl. CPC C08G 18/12; C08G 18/7621; C08G 18/7614; C08G 18/3865; C08G 18/3819; C08G 18/3844

(57) ABSTRACT

The invention relates to a method for producing a polyurethane prepolymer with an isocyanate termination, having a low content of free diisocyanates. The invention also relates to a method for producing polyurethanes, polyurethane urea or thermoplastic polyurethane granules.

### FIELD OF THE INVENTION

The present invention relates to the preparation of isocyanate-terminated polyurethane prepolymers having a free diisocyanate monomers content of less than or equal to 0.1% by mass. These isocyanate-terminated polyurethane prepolymers are useful for preparing polyurethanes, polyurethane ureas or thermoplastic polyurethane pellets.

### BACKGROUND OF THE INVENTION

Polyurethanes count among the most polyvalent commercial materials. Thermosetting or thermoplastic, polyurethanes are used in a large number of industries. For example, they can be used to form flexible foams particularly used in furnishings and in the automobile industry or rigid foams used as insulators in building construction or electric household appliances. Polyurethanes also enter into the composition of many adhesives, lacquers, varnishes, paints, etc.

Many methods for preparing polyurethanes have been developed. For example, polyurethanes can be prepared in a single step by mixing the various polymer components, generally in the absence of solvent. They can also be prepared from isocyanate-terminated prepolymers formed by reaction between an isocyanate, typically employed in large excess, and a polyol. In this latter method, the reaction of the prepolymer with a chain extender and/or a crosslinking agent leads to the formation of polyurethane. Polyurethane prepolymers prepared conventionally generally contain a significant proportion of unreacted isocyanate, referred to herein as “free isocyanate”.

Isocyanates are toxic compounds. At high concentrations, they can irritate the skin and the mucous membranes. Continuous exposure to low concentrations can, as for it, be at the origin of a sensitization leading to skin or respiratory allergies. Certain isocyanates even prove to be carcinogenic. Their penetration into the organism occurs mainly via the respiratory tract in vapor or aerosol form. Toluene diisocyanate (TDI), diphenylmethylene diisocyanate (MDI) and p-phenyl diisocyanate (PPDI) prove to be particularly noxious because of their high volatility.

Since the coming into force of the REACH regulation of the European Union, certain chemical substances or groups of chemical substances are for certain uses subject to marketing and use restrictions. In particular, since December 2010, the marketing of products containing more than 0.1% of free MDI or TDI is strictly regulated.

Furthermore, other than the health problems they can cause, free isocyanates present in isocyanate-terminated prepolymers can alter the properties of the polyurethanes formed from these prepolymers. Indeed, free isocyanates can react with chain extenders creating isolated rigid segments at the origin of phase separation problems.

To overcome these disadvantages and to reduce health risks, efforts have been undertaken to reduce the free isocyanate contents in isocyanate-terminated prepolymers. Free isocyanates are generally removed by vacuum distillation, giving rise to substantial additional preparation costs.

There is thus a need to have a method for obtaining isocyanate-terminated polyurethane prepolymers having a low free diisocyanate content (less than or equal to 0.1%) at a lower cost.

### BRIEF DESCRIPTION OF THE INVENTION

The present invention relates to a method for preparing an isocyanate-terminated polyurethane prepolymer having a free diisocyanate monomers content of less than or equal to 0.1% by mass relative to the total mass of the prepolymer and having an NCO value of 2 to 6, said method comprising the following steps:
a) reacting at a temperature of 20 to 70° C. with degassing:
   i. diisocyanate monomers selected from diisocyanates having two NCO functions having a difference in reactivity higher than 6, said difference in reactivity resulting from the dissymmetry of the monomers and/or from a substitution effect;
   ii. polyols with a functionality of 2 having a molar mass of 150 to 3000 g/mol; the diisocyanate monomers and the polyols being in such a quantity that the ratio of “number of NCO functions” to “number of OH functions” varies from 1.4 to 2;
b) degassing and stabilizing the reaction medium obtained in step a) at a temperature of 50° C. to 110° C.;
c) recovering said isocyanate-terminated polyurethane prepolymer.

The present invention also relates to the use of an isocyanate-terminated polyurethane prepolymer obtained according to the preceding method for preparing polyurethanes by low-pressure or high-pressure casting, or by means of a liquid-injection machine.

The present invention also relates to the use of an isocyanate-terminated polyurethane prepolymer obtained according to the preceding method for preparing thermoplastic pellets, in particular by means of an extruder with underwater pelletizing then injection in a press.

The present invention relates to a method for preparing a polyurethane, polyurethane urea or thermoplastic polyurethane (TPU) pellets, comprising the following steps:
iv) preparing an isocyanate-terminated polyurethane prepolymer having a free diisocyanate monomers content of less than or equal to 0.1% by mass relative to the total mass of the prepolymer and having an NCO value of 2 to 6 according to the preceding method;
v) reacting the prepolymer obtained in step iv) with polyols or/and polyamines, said polyols and polyamines having an average molar mass of 50 to 4000 g/mol and an average functionality equal to or greater than 2;
vi) recovering said polyurethane, polyurethane urea or TPU pellets.

Definitions

In the context of the present invention, unless otherwise specified, percentages are percentages by mass.

According to the present invention, the terms “degassing” or “degas” relate to all techniques known to the skilled person for eliminating gases contained in the chamber in which the method for preparing a polyurethane prepolymer according to the present invention is carried out. For example, a simple pump can be connected to evacuate gas from the chamber and thus to lower the gas pressure thereof. Advantageously, the chamber pressure is close to 0.5 atmosphere (±0.1 atmosphere), more advantageously close to 0.25 atmosphere (±0.1 atmosphere), still more advantageously close to 0.1 atmosphere (±0.1 atmosphere), and in particular 0 atmosphere.

The ratio of “number of NCO functions” to “number of OH functions” according to the present invention can be determined theoretically on the basis of the structure and quantity of the diisocyanates and polyols involved. Alternatively, any assay technique for determining the number of both NCO and OH functions is applicable.

By the term “stabilization” or “stabilizing”, for example in the expression “stabilizing the reaction medium obtained in step a) at a temperature of 50° C. to 110° C.”, it is meant that the temperature is maintained at a value for a determined period of time, which is besides the generally accepted definition of this term. Advantageously, this temperature value can nevertheless exhibit small variations on the order of±10° C., indeed±5° C. The stabilized temperature values can be between 60 and100° C., between 70 and 90° C., between 75 and 85° C., preferentially 80° C. The determined period in the context of the present invention can vary from several minutes (for example 10 minutes, 20 minutes, 30 minutes or 45 minutes) to several hours (thus after one hour, indeed 2 hours, 3 hours, 5 hours, 10 hours or 15 hours). This time period is a function of the technical effect disclosed in the present patent application, which is to limit the free isocyanates content. This time period is also a function of the desired yield, i.e., the optimum reaction yield. The skilled person will thus adapt this time value to the technical effect sought.

The expression “molar mass” in the context of the present invention relates to the mass average molar mass (also referred to as “by weight”) according to the general definition the skilled person can apply:

$${\overline{M}}_{w} = \frac{{Σ}_{i} {m}_{i} \times {M}_{i}}{{Σ}_{i} {m}_{i}} = \frac{{Σ}_{i} {N}_{i} \times {M}_{i}^{2}}{{Σ}_{i} {N}_{i} \times {M}_{i}}$$

Any technique known in the art for determining this average molar mass is applicable to the present invention, for example by dynamic light scattering, ultracentrifugation, mass spectrometry (e.g., MALDI-TOF), or by any applicable chromatography technique such as exclusion (also referred to as “size exclusion”) or on permeable gel.

Viscosity, as the skilled person well knows, expresses, in short, a fluid's resistance to flow. Viscosity can be measured by any technique known by the skilled person at the selected temperature. For example, in the context of the present invention, it is possible to use a Brookfield-type viscometer at the selected temperature. Advantageously, the viscosity of the isocyanate-terminated polyurethane prepolymer is lower than 6000 mPa·s at a temperature between 85° C. and 105° C., preferentially 95° C.

### DETAILED DESCRIPTION OF THE INVENTION

The inventors have shown that isocyanate-terminated polyurethane prepolymers having a free diisocyanate monomers content of less than or equal to 0.1% by mass relative to the total mass of the prepolymer and having an NCO value of 2 to 6 could be prepared by a method comprising the following steps:
a) reacting at a temperature of 20 to 70° C. with degassing:
   i. diisocyanate monomers selected from diisocyanates having two NCO functions having a difference in reactivity higher than 6, the difference in reactivity resulting from the dissymmetry of the monomers and/or from a substitution effect;
   ii. polyols with a functionality of 2 having a molar mass of 150 to 3000 g/mol; the diisocyanate monomers and the polyols being in such a quantity that the ratio of “number of NCO functions” to “number of OH functions” varies from 1.4 to 2;
b) degassing and stabilizing the reaction medium obtained in step a) at a temperature of 50° C. to 110° C.;
c) recovering said isocyanate-terminated polyurethane prepolymer.

Advantageously, the method developed by the inventors does not include a distillation step. Thus, the isocyanate-terminated polyurethane prepolymer is recovered directly after carrying out steps a) and b).

The NCO value of the isocyanate-terminated polyurethane prepolymers is a measured value. It can be determined by assay according to the standard NF T52 132.

The NCO value of the isocyanate-terminated polyurethane prepolymers varies from 2 to 6. More particularly, the NCO value of the isocyanate-terminated polyurethane prepolymers can vary from 2.2 to 5.3.

The free diisocyanate monomers content in the isocyanate-terminated polyurethane prepolymers can be determined by gas chromatography according to the standard NF EN ISO 10283.

The diisocyanate monomers are selected from diisocyanates having two NCO groups having a difference in reactivity higher than 6, the difference in reactivity resulting from the dissymmetry of the monomers and/or from a substitution effect. This difference in reactivity is given in the scientific literature (Pascault et al., “Thermosetting Polymers” Ed. M. Dekker, 2002, Chap. 2 page 18: “The reactivity of diisocyanates is well documented in the literature. For symmetric diisocyanates such as diphenylmethane 4,4′-diisocyanate (MDI) or para-phenylene 4,4′-diisocyanate (PPDI), both NCO groups have initially the same reactivity. But as the NCO group itself exhibits an activating effect on isocyanate reactivity, the fact that one NCO group has reacted introduces a substitution effect that usually decreases the reactivity of the second NCO group.

This effect is more pronounced in PPDI than in MDI; the ratio of the rate constants for the reaction with an aliphatic alcohol is k₁/k₂=9 and k₁/k₂=2, respectively (at room temperature).

Asymmetric diisocyanates such as 2,4-TDI are more complex because the initial reactivity of the two isocyanate groups is not equivalent and the substitution effect amplifies the difference. The 4-NCO is about 10-20 times more reactive than the 2-NCO, but the reactivity ratio also depends on temperature (see Chapter 5). This difference also explains why the TDI dimer can be prepared quantitatively (Eq. 2.28).”).

Consequently, it is clear that the term “reactivity” employed in the present invention corresponds to the reaction rate of an NCO group with an OH group and the “difference in reactivity” is the ratio of the reaction rates between the first NCO group and the second NCO group which react with a polyol.

Reaction of the first NCO group: V₁=k₁[NCO₁][OH]

Reaction of the second NCO group: V₂=k₂[NCO₂][OH]

and V₁/V₂=k₁/k₂.

Preferably, the difference in reactivity is higher than 8.

When the difference in reactivity results from a substitution effect, the diisocyanate monomers can be symmetrical molecules having two NCO groups of equal reactivity. When one of these NCO groups reacts, a substitution effect is produced which usually decreases the reactivity of the second NCO group.

The diisocyanate monomers can be aliphatic, aromatic or cycloaliphatic. Preferably, the diisocyanate monomers are aromatic. More particularly, the diisocyanate monomers can be selected from the group comprising toluene-2,4-diisocyanate (2,4 TDI), 1,4-phenylene diisocyanate (PPDI) and a mixture thereof.

The polyols used in the method for preparing prepolymers have a functionality of 2 and a molar mass of 150 to 3000 g/mol, preferably 250 to 3000 g/mol or 250 to 2000 g/mol. The functionality of the polyol refers to the number of hydroxyl groups per molecule. Such polyols are well-known to the skilled person.

The polyols can be selected from the group comprising polyesters, polyethers, polycarbonates, polyolefins and mixtures thereof.

More particularly, the polyols can be selected from the group comprising polymers of 1-2 propylene glycol, of 1-3 propylene glycol, of ethylene glycol, of butylene glycol, polycaprolactones, polytetramethylene glycols, polyolefins of the polybutadiene and hydrogenated polybutadiene type, polyols derived from fatty acids and vegetable oils, such oils derived from colza, castor oil plants, soya, and mixtures thereof.

In certain embodiments of the present invention, the diisocyanate monomers and the polyols are selected from the following combinations:
1,4-phenylene diisocyanate and/or toluene-2,4-diisocyanate and polycaprolactones;
1,4-phenylene diisocyanate and/or toluene-2,4-diisocyanate and polyethers;
1,4-phenylene diisocyanate and/or toluene-2,4-diisocyanate and polyolefins of vegetable origin.

The diisocyanate monomers and the polyols are in such a quantity that the ratio of “number of NCO functions” to “number of OH functions” varies from 1.4 to 2, preferably from 1.45 to 1.65.

The reaction between the diisocyanate monomers and the polyols according to step a) of the method of the present invention is typically carried out in the absence of catalyst and/or under vacuum. Step a) is carried out at a temperature of 20 to 70° C., indeed 20° C. to 60° C.

The viscosity of the product of the reaction between the diisocyanate monomers and the polyols is controlled by the temperature, the NCO/OH ratio and the molar masses of the polyols. The skilled person will be able to adapt these parameters in such a way that the viscosity of the product obtained in step a) does not exceed 6000 mPa·s at the selected temperature.

The stabilization of the product resulting from step a) is carried out at a temperature of 50° C. to 110° C., preferably 65° C. to 100° C. Stabilization is preferably carried out under vacuum. Generally, steps a) and b) (combined) are carried out with stirring for at least 15 hours.

The isocyanate-terminated polyurethane prepolymers obtained by the method of the present invention can be used to prepare polyurethanes or polyurethane ureas. They can also be used to prepare TPU pellets. Polyurethanes or polyurethane ureas can be prepared by low-pressure or high-pressure casting or by means of a liquid-injection machine. TPU pellets can be prepared by means of an extruder, in particular an extruder with underwater pelletizing then injection in a press.

Thus, the present invention also relates to a method for preparing a polyurethane, polyurethane urea or TPU pellets comprising the following steps:
iv) preparing an isocyanate-terminated polyurethane prepolymer having a free diisocyanate monomers content of less than or equal to 0.1% by mass and having an NCO value of 2 to 6 according to the method described above;
v) reacting the prepolymer obtained in step iv) with polyols or/and polyamines of average molar mass of 50 to 4000 g/mol, and average functionality equal to or greater than 2;
vi) recovering said polyurethane, polyurethane urea or TPU pellets.

The polyols or amines of average functionality equal to 2 are generally referred to by the term “chain extenders”. Chain extenders can be aliphatic or aromatic.

Examples of chain extenders include diols, such as for example ethylene glycol, 1,4-butanediol, 1,3-propanediol, hydroquinone bis(2-hydroxyethyl)ether, isosorbide and isomers thereof or polyethers, polycaprolactones, polyesters, polycarbonates, polyolefins and polyols derived from fatty acids or vegetable oils as described above and mixtures thereof.

Examples of chain extenders include diamines, such as for example 6-methyl-2,4-bis(methylthio)phenylene-1,3-diamine, 3,5-diethyltoluene-2,4-diamine, 4,4-methylene bis(3-chloro-2,6-diethylaniline) and mixtures thereof.

The polyols or amines of average functionality higher than 2 are generally referred to by the term “crosslinking agents”. Examples of crosslinking agents include glycerol, sorbitol, trimethylolpropane and castor oil.

The polyols or/and polyamines useful in step v) of the method have an average molar mass of 50 to 4000 g/mol, preferably 50 to 500 g/mol and even more preferably 50 to 250 g/mol.

Monoalcohols and/or monoamines serving as chain limiters can also be added to the polyols or/and polyamines of step v). Examples of chain limiters include 1-(2-aminoethyl)-2-imidazolidinone or UDETA (Reverlink® FA from Arkema) and 2-morpholino ethylamine.

The polyurethanes obtained by the method described above are free of isolated rigid segments. The absence of isolated rigid segments makes possible the use of monofunctional chain limiters able to create supramolecular bonds.

In certain embodiments, the prepolymer is obtained by reaction between 1,4-phenylene diisocyanate and a polycaprolactone, and the chain extender is hydroquinone bis(2-hydroxyethyl)ether or 1,4-butanediol.

In other embodiments, the prepolymer is obtained by reaction between 1,4-phenylene diisocyanate and a polyether, and the chain extender is 1,4-butanediol.

The components necessary to step iv) and v) can be introduced into an extruder, such as a twin-screw extruder, to prepare thermoplastic polyurethane (TPU) pellets.

The present invention also relates to a method for preparing thermoplastic polyurethane pellets comprising the mixing of an isocyanate-terminated polyurethane prepolymer obtained according to the method described above with a chain extender having a functionality of 2 in an extruder coupled to an underwater pelletizer.

The polyurethane elastomers and the TPU obtained by the method of the present invention have properties at least equivalent, if not superior to polyurethanes prepared from isocyanate-terminated polyurethane prepolymer the preparation of which includes a distillation step. In particular, the polyurethanes have excellent mechanical and chemical properties:
Resistance to solvents, fluids and hydrolysis;
Resistance to abrasion, tearing and cutting;
Compression set, Resilience;
Excellent behavior under UV and at high temperatures;
Excellent isotropy properties;
Barrier and acoustic properties.

### EXAMPLES

Preparation of Isocyanate-Terminated Polyurethane Prepolymers

TABLE 1
The following isocyanate-terminated polyurethane prepolymers were prepared:

| Formulation | | | | | |
|---|---|---|---|---|---|
| Parts by weight | Prepolymer 1 | Prepolymer 2 | Prepolymer 3 | Prepolymer 4 | Prepolymer 5 |
| Diisocyanate | TDI 100 | TDI 100 | TDI 100 | PPDI | PPDI |
| | 34.4 | 12.93 | 29.22 | 14.116 | 16.7 |
| Polyol¹ | Terathane 250 | RADIA 7282 | PRIPOL 2033 | CAPA 2201A | CAPA 2201A |
| | 11.75 | 87.07 | 53.92 | 77.341 | 23.32 |
| Polyol¹ | Terathane 650 | — | RADIA 7282 | CAPA 2043 | CAPA 2101A |
| | 53.15 | | 16.86 | 8.543 | 59.71 |
| Antioxidant | Ethanox 310 | — | — | — | Irganox 1010/ |
| | 0.7 | | | | Irgafos 168 |
| | | | | | 0.09/0.18 |
| Theoretical | 5.74 | 2.45 | 5.00 | 2.30 | 2.72 |
| NCO value | | | | | |
| NCO² value | 5.22 | 2.29 | 4.69 | 2.20 | 2.52 |
| Viscosity³ | 2500 mPa · s at | 3670 mPa · s at | 1850 mPa · s at | 4900 mPa · s at | 5000 mPa · s at |
| | 80° C. | 85° C. | 85° C. | 100° C. | 85° C. |
| Tg | −32.5° C. | −48.3° C. | −17.2° C. | −44.0° C. | −40.0° C. |
| Free | 0.04% | 0.04% | 0.09% | 0.088% | 0.1% |
| diisocyanate | | | | | |
| content⁴ | | | | | |

¹Polyol with a functionality of 2
²Measured according to the standard NF T52 132
³Measured by means of a LAMY TVe-05 viscometer
⁴Measured according to the standard NF EN ISO 10283

The TDI 100 and the PPDI are as provided by VENCOREX, France and DKSH, France, respectively.

The polyols used are provided by:
Perstorp (CAPA™ 2043, CAPA™ 2201A, CAPA™ 2101A)
Invista (Terathane® 250, Terathane® 650)
Croda (PRIPOL™ 2033)
Novance/Oleon (RADIA 7282)

TABLE 2
Perstorp CAPA 2043 POLYCAPROLACTONE

| | | | | Specifications | |
|---|---|---|---|---|---|
| Characteristics | Units | Result | | Minimum | Maximum |
| Hydroxyl value | mg/g | 282.8000 | mg/g | 265 | 295 |
| (KOH) | | | | | |
| Acid value | mg/g | 0.0800 | mg/g | — | 0.25 |
| (KOH) | | | | | |
| Water | % (m) | 0.0150% | (m) | — | 0.020 |
| Color | Hazen | 20 | Hazen | — | 50 |

| | | | | |
|---|---|---|---|---|
| Clearness-clear | — | CONF | 0 | 0 |
| liquid gloss | | | | |

TABLE 3
Perstorp CAPA 2101A POLYCAPROLACTONE

| | | | | Specifications | |
|---|---|---|---|---|---|
| Characteristics | Units | Result | | Minimum | Maximum |
| Hydroxyl value | mg/g | 113.0000 | mg/g | 108 | 116 |
| (KOH) | | | | | |
| Acid value | mg/g | 0.0200 | mg/g | — | 0.05 |
| (KOH) | | | | | |
| Water | % (m) | 0.0100% | (m) | — | 0.020 |
| Color | Hazen | <10 | Hazen | — | 20 |

TABLE 4
Perstorp CAPA 2201A POLYCAPROLACTONE

| | | | | Specifications | |
|---|---|---|---|---|---|
| Characteristics | Units | Result | | Minimum | Maximum |
| Hydroxyl value | mg/g | 57.1000 | mg/g | 54.0 | 58.0 |
| (KOH) | | | | | |
| Acid value | mg/g | 0.0200 | mg/g | — | 0.05 |
| (KOH) | | | | | |
| Water | % (m) | 0.0150% | (m) | — | 0.020 |
| Color | Hazen | <20 | Hazen | — | 50 |

TABLE 5
TETRATANE ® 250

| | | | |
|---|---|---|---|
| Molecular mass | | 255 | 230-270 |
| Color (APHA) | Hazen | 14 | Max. 40 |
| Water | ppm | 78 | Max. 150 |
| Alkalinity number | MeqOH/30 kg | −1.01 | −2.0-+1.0 |
| Hydroxyl number | | 440.0 | 488-416 |

TABLE 6
TETRATANE ® 650

| Product properties | | Batch analysis | Minimum | Maximum |
|---|---|---|---|---|
| Molecular mass | | 658 | 625 | 675 |
| Color (APHA) | Hazen | 20 | 0 | 50 |
| Water | ppm | 66 | 0 | 150 |
| Alkalinity | MeqOH/30 kg | −0.62 | −2.00 | 1.00 |
| number | | | | |
| Hydroxyl | | 170.5 | 166.2 | 179.5 |
| number | | | | |

TABLE 7
TETRATANE ® 2000

| Product properties | | Batch analysis | Minimum | Maximum |
|---|---|---|---|---|
| Molecular mass | | 2027 | 1900 | 2100 |
| Color (APHA) | Hazen | 11 | 0 | 40 |
| Water | ppm | 49 | 0 | 150 |
| Alkalinity | MeqOH/30 kg | −0.91 | −2.00 | 1.00 |
| number | | | | |
| Hydroxyl | | 55.4 | 53.4 | 59.1 |
| number | | | | |

TABLE 8
CRODA PRIPOL 2033-LQ-(GD)

| Method | | Standards | | Results | | |
|---|---|---|---|---|---|---|
| no. | Analysis | Mini | Maxi | Unit value | Units | Conformity |
| | ADDEND00 | CONFORMS | | CONFORMS | — | P |
| | | Y/N | | | | |
| AAF00000 | Revision number | 20.0 | | CONFORMS | — | P |
| EF100100 | ACID VALUE | 0.00 | 0.20 | 0.05 | mg/KOH/g | P |
| EF100700 | SAPONIFICATION | 0.0 | 2.0 | 0.4 | mg/KOH/g | P |
| | VALUE | | | | | |
| EF100200 | HYDROXYL | 202 | 212 | 210 | mg/KOH/g | P |
| | VALUE | | | | | |
| LF100600 | APHA COLOR | 0 | 50 | 5 | Hazen | P |
| EF100300 | WATER | 0.00 | 0.10 | 0.07 | % | P |
| LF934100 | MONOMER | 0.0 | 2.0 | 0.5 | % | P |
| | ALCOHOL | | | | | |
| LF934100 | DIMER INCL. 1.5- | 96.5 | 100.0 | 98.7 | % | P |
| | MER ALCOHOL | | | | | |
| LF934100 | TRIMER | 0.0 | 1.5 | 0.8 | % | P |
| | ALCOHOL | | | | | |

TABLE 9
Oleon: Radia 7282

| Analysis results | Units | Result | Min. | Max. | Method |
|---|---|---|---|---|---|
| Acid value | Mg KOH/g | 0.70 | 0.00 | 1.00 | AOCS cd 3d-63 |
| Water | % (m) | 0.01 | 0.00 | 0.10 | AOCS Ca 2^{nd}-84 |
| Hydroxyl | | 57.9 | 52.0 | 60.0 | Novance A76 |
| value | | | | | |
| Viscosity at | | 26.8 | 25.0 | 35.0 | Novance B326 |
| 40° C. | | | | | |

Preparation of Prepolymer 1

Preparation of the Polyols Mixture

TERATHANE 250 and then TERATHANE 650 are loaded into a tank. The mixture is placed at 100° C. with vigorous stirring (195 rpm) under vacuum. The mixture of TERATHANE 250 and ETHANOX 310, first melted in an oven at 125° C. with stirring, is then added. The mixture is then stabilized for 17 hours under vacuum at 41° C. with stirring at 70 rpm.

Preparation of the Prepolymer

Liquid TDI is introduced from the top into a reactor tank at 27±3° C. The homogeneous mixture of polyols at 41±1° C. is introduced by pumping from the bottom with stirring at 70 rpm. When all the polyols mixture is pumped in, stirring is increased to 235 rpm. The whole is then subjected to a vacuum. During the exothermic phase, the setpoint temperature of the tank is controlled so that the temperature of the mixture does not exceed 60±5° C. and then the product is stabilized at 65±2° C. The whole is then stirred for at least 15 hours under vacuum at 215 rpm at 65° C. The product obtained is then stabilized for 2 hours at 80° C. and degassed.

Preparation of Prepolymer 2

Liquid TDI is introduced from the top into a reactor tank at 27±3° C. The polyol at 55±1° C. is introduced by pumping from the bottom with stirring at 70 rpm. When all the polyols mixture is pumped in, stirring is increased to 235 rpm. The whole is subjected to a vacuum. During the exothermic phase, the setpoint temperature of the tank is controlled so that the temperature of the mixture does not exceed 60±5° C. and then the product is stabilized at 65±2° C. The whole is stirred at 215 rpm under vacuum for at least 15 hours. The product is then stabilized for 2 hours at 80° C. and degassed.

Preparation of Prepolymer 3

Preparation of the Mixture of RADIA 7282 and PRIPOL 2033

PRIPOL 2033 and then RADIA 7282 are loaded into a tank placed at 90° C.-100° C. The mixture is brought up to 100° C. with stirring at 195 rpm under vacuum. The mixture is stabilized for 12 hours to maintain the polyols at 53±1° C.

Preparation of the Prepolymer

Liquid TDI is introduced from the top into a reactor tank at 27±3° C. The homogeneous polyols mixture at 53±1° C. is introduced by pumping from the bottom with stirring at 70 rpm. When all the polyols mixture is pumped in, stirring is increased to 235 rpm. The whole is subjected to a vacuum. During the exothermic phase, the setpoint temperature of the tank is controlled so that the temperature of the mixture does not exceed 60±5° C. and then the product is stabilized at 65±2° C. The whole is stirred at 215 rpm under vacuum for at least 15 hours. The product is then stabilized for 2 hours at 80° C. and degassed.

Preparation of Prepolymer 4

Preparation of the Mixture of CAPA 2201A and CAPA 2043

CAPA 2043 and then CAPA 2201A are loaded into a tank placed at 90° C.-100° C. The mixture is brought up to 100° C. with stirring at 195 rpm under vacuum. The mixture is stabilized for 12 hours to maintain the polyols at 45±1° C.

Preparation of the Prepolymer

PPDI in straw form is introduced from the top into a reactor tank at 45±1° C. The homogeneous polyols mixture at 45±1° C. is introduced by pumping from the top with stirring at 70 rpm. When all the polyols mixture is pumped in and all the PPDI wetted, stirring is increased to 230 rpm. The whole is subjected to a vacuum. After the exothermic phase, the product is stabilized at 65±2° C. The whole is stirred at 195 rpm under vacuum for at least 15 hours. The product is then stabilized for 2 hours at 80° C., and brought up to 100° C. under vacuum to degas it.

Preparation of Prepolymer 5

Preparation of the Mixture of CAPA 2201A and CAPA 2101A

CAPA 2101A and then CAPA 2201A are loaded into a tank placed at 90° C.-100° C. The mixture is brought up to 100° C. with stirring at 195 rpm under vacuum. The mixture is stabilized for 12 hours to maintain the polyols at 46±1° C.

Preparation of the Prepolymer

PPDI in straw form is introduced from the top into a reactor tank at 46±1° C. The homogeneous polyols mixture at 46±1° C. is introduced by pumping from the top with stirring at 70 rpm. When all the polyols mixture is pumped in and all the PPDI wetted, stirring is increased to 150 rpm and the whole is subjected to a vacuum. After the exothermic phase, the product is stabilized at 65±2° C. The whole is stirred at 215 rpm under vacuum for at least 15 hours. The product is then stabilized for 2 hours at 80° C., and brought up to 100° C. under vacuum to degas it.

Preparation of Polyurethane Elastomers

TABLE 10
The following polyurethanes were prepared:

| Composition | | | | | |
|---|---|---|---|---|---|
| Parts by weight | PolyU 1 | PolyU 2 | PolyU 3 | PolyU 4 | PoIyU 5 |
| Prepolymer | Prepolymer 1 | Prepolymer 1 | Prepolymer 2 | Prepolymer 3 | Prepolymer 4 |
| | 100 | 100 | 100 | 100 | 100 |
| Extender | Ethacure 300 | MCDEA | Ethacure 300 | 2-Morpholino | BDO |
| | 12.8 | 19.6 | 5.46 | ethylamine | 2.247 |
| | | | | 5.21 | |
| Extender | — | TERA 2000 | — | Polycin D-4000 | — |
| | | 15.00 | | 59.06 | |
| Extender | — | — | — | Ethacure 300 | — |
| | | | | 4.00 | |
| Curing | 16 h | 16 h | 16 h | 16 h | 16 h |
| Tps ant T° C. | 100° C. | 130° C. | 100° C. | 130° C. | 130° C. |

The polyurethanes are prepared by methods well-known to the skilled person.

The chain extenders used are provided by:
Albermarle (Ethacure 300)
Aceto (MCDEA)
Invista (Terathane 2000)
Sigma Aldrich (2-morpholinoethylamine)
Vertellus (Polycin D-4000)
BASF (BDO)

TABLE 11
3208 ETHACURE 300/DR 55 C/Z00001

| | | | | Upper | |
|---|---|---|---|---|---|
| Characteristics | Units | Value | Lower limit | limit | Method |
| Water | % weight | 0.01 | — | 0.08 | |
| Amine value | | 529 | 526 | 536 | |
| Color | | 8 | — | 13 | |
| (Gardner) | | | | | |
| Total diamines | % weight | 99.8 | 99.0 | — | |

TABLE 12
ACETO FRANCE SAS, 4,4-METHYLENE BIS(3-CHLORO-2,6-
DIETHYLANILINE)

| | SPECIFICATIONS | RESULTS |
|---|---|---|
| Appearance | White to off-white pellets | Conforms |
| Purity | 97% min | 98.7% |
| Water content | 0.15% max | 0.043% |
| Melting point | 87.0-89.0° C. | 87.4-89.0° C. |

TABLE 13
TETRATANE ® 2000

| | | Batch | | |
|---|---|---|---|---|
| Product properties | | analysis | Minimum | Maximum |
| Molecular mass | | 2027 | 1900 | 2100 |
| Color (APHA) | Hazen | 11 | 0 | 40 |
| Water | ppm | 49 | 0 | 150 |
| Alkalinity value | MeqOH/30 kg | −0.91 | −2.00 | 1.00 |
| Hydroxyl value | | 55.4 | 53.4 | 59.1 |

TABLE 14
BASF, BDO, 1,4-Butanediol

| Test characteristics | | Results | Specification | Test method |
|---|---|---|---|---|
| Test | % | 99.729 | >=99.500 | GC |
| 2-Methylbutane- | % | 0.083 | <=0.400 | GC |
| 1,4-diol | | | | |
| Acetal | % | 0.091 | <=0.150 | GC |
| Water | ppm | 43 | <=200 | DIN 51 777 |
| Color | APHA | 4 | <=7 | DIN EN 1567 |

Preparation of polyU 1

The prepolymer at 80° C. and the chain extender at 40° C. are mixed.

The curing time and temperature are as indicated in the table above.

Preparation of polyU 2

The prepolymer at 85° C. and the extenders at 95° C. are mixed.

The curing time and temperature are as indicated in the table above.

Preparation of polyU 3

The prepolymer at 80-85° C. and the extender at 40° C. are mixed.

The curing time and temperature are as indicated in the table above.

Preparation of polyU 4

The prepolymer at 95-100° C. and the extenders at 95-100° C. are mixed.

The curing time and temperature are as indicated in the table above.

Preparation of polyU 5

The prepolymer at 85-90° C. and the extender at room temperature are mixed.

The curing time and temperature are as indicated in the table above.

TABLE 15
Properties of the polyurethanes obtained

| | Polyurethane | | | | |
|---|---|---|---|---|---|
| | PolyU 1 | PolyU 2 | PolyU 3 | PolyU 4 | PolyU 5 |
| Pot life¹ | 2 min 30 | 1 min 30 | 3 min | 12 min | 6-7 min |
| Tg | −21.3° C. | −36.1 | −51.0° C. | −34.3° C. | −50.2° C. |
| Hardness² | 97 | 97 | 82 | — | 94 |
| (Shore A) | | | | | |
| Tensile strength³ | 50.9 | 52 | 27.7 | 2.59 | 37 |
| (Mpa) | | | | | |
| Elongation at break⁴ | 280 | 360 | 575 | 450 | 590 |
| (%) | | | | | |
| Resistance to tear | 123 | 115 | 48.4 | — | 82.9 |
| propagation⁵ | | | | | |
| (kN/m) | | | | | |
| Compression set | 27 | 30 | 28 | — | 48 |
| 25%⁶ | | | | | |
| 22 h-70° C. | | | | | |
| Water uptake | 1.8% | 1.9% | 0.6% | — | 1.6% |
| 72 hours 80° C. | | | | | |
| Adhesion after cutting | — | — | — | 37%-1 hour | — |
| | | | | 50%-1 night | |

¹Time after which the mixed product cannot be cast
²Measured according to the standard ISO 868
³Measured according to the standard ISO 37 (Determination of tensile stress-strain properties)
⁴Measured according to the standard ISO 37 (Determination of tensile stress-strain properties)
⁵Measured according to the standard ISO 34-1 (Determination of tear strength)
⁶Measured according to the standard ISO 815 (Determination of compression set)

Preparation of Thermoplastic Polyurethane Pellets

Preparation of TPU 1

The prepolymer at 90° C.-130° C. and the chain extender at 130° C. are mixed in a twin-screw extruder including several heated zones at temperatures between 200° C. and 280° C. TPU pellets are obtained by underwater pelletizing using blades. The pellets are dried for 2 hours at 80-110° C.

These pellets end by being injected in a press.

TABLE 16
Preparation of TPU 1

| Composition | |
|---|---|
| Parts by weight | TPU 1 |
| Prepolymer | Prepolymer 5 |
| | 100 |
| Extender | HQEE⁶ |
| | 5.5 |
| Hardness¹ (Shore A) | 88 |
| Tensile strength² | 45 |
| (Mpa) | |
| Elongation at break³ | 590 |
| (%) | |
| Resistance to tear propagation⁴ | 91 |
| (kN/m) | |
| Compression set 25%⁵ | |
| 22 h-70° C. | 14 |
| 22 h-100° C. | 26 |

¹Measured according to the standard ISO 868
²Measured according to the standard ISO 37 (Determination of tensile stress-strain properties)
³Measured according to the standard ISO 37 (Determination of tensile stress-strain properties)
⁴Measured according to the standard ISO 34-1 (Determination of tear strength)
⁵Measured according to the standard ISO 815 (Determination of compression set)
⁶Provided by the company Monument Chemical.

1. Method for preparing an isocyanate-terminated polyurethane prepolymer having a free diisocyanate monomers content of less than or equal to 0.1% by mass and having an NCO value of 2 to 6, said method comprising the following steps:
a) reacting at a temperature of 20 to 70° C. with degassing:
i. diisocyanate monomers selected from diisocyanates having two NCO groups having a difference in reactivity higher than 6, said difference in reactivity resulting from the dissymmetry of the monomers and/or from a substitution effect;
ii. polyols with a functionality of 2 having an average molar mass of 150 to 3000 g/mol;
the diisocyanate monomers and the polyols being in such a quantity that the ratio of “number of NCO functions” to “number of OH functions” varies from 1.4 to 2;
b) degassing and stabilizing the reaction medium obtained in step a) at a temperature of 50° C. to 110° C.;
c) recovering said isocyanate-terminated polyurethane prepolymer.

2. Method according to claim 1, wherein the viscosity of the isocyanate-terminated polyurethane prepolymer is lower than 6000 mPa·s.

3. Method according to claim 1 wherein the diisocyanate monomers are selected from the group comprising toluene-2,4-diisocyanate, 1,4-phenylene diisocyanate and a mixture thereof.

4. Method according to claim 1, wherein the polyols are selected from the group comprising polyesters, polyethers, polycarbonates, polyolefins and mixtures thereof.

5. Method according to claim 4, wherein the polyols are selected from the group comprising polymers of 1-2 propylene glycol, of 1-3 propylene glycol, of ethylene glycol, of butylene glycol, polycaprolactones, polytetramethylene glycols, polybutadienes, hydrogenated polybutadienes, polyols derived from fatty acids and vegetable oils and mixtures thereof.

6. Method according to claim 1, wherein the diisocyanate monomers and polyols are selected from the following combinations:
1,4-phenylene diisocyanate and/or toluene-2,4-diisocyanate and polycaprolactones;
1,4-phenylene diisocyanate and/or toluene-2,4-diisocyanate and polyethers; or
1,4-phenylene diisocyanate and/or toluene-2,4-diisocyanate and polyolefins of vegetable origin.

7. Method according to claim 1, wherein step a) is carried out in the absence of catalyst.

8. Method according to claim 1, wherein steps a) and b) are carried out under vacuum and/or with stirring for at least 15 hours.

9. Method for preparing a polyurethane, said polyurethanes being prepared by low-pressure or high-pressure casting or a liquid-injection machine, or for preparing thermoplastic polyurethane (TPU) pellets using an isocyanate-terminated polyurethane prepolymer obtained according to the method of claim 1.

10. Method for preparing a polyurethane, polyurethane urea or thermoplastic polyurethane (TPU) pellets comprising the following steps:
iv) preparing an isocyanate-terminated polyurethane prepolymer having a free diisocyanate monomers content of less than or equal to 0.1% by mass and having an NCO value of 2 to 6 according to the method of claim 1;
v) reacting the prepolymer obtained in step iv) with polyols or/and polyamines, said polyols and polyamines having an average molar mass of 50 to 4000 g/mol and an average functionality equal to or greater than 2;
vi) recovering said polyurethane, polyurethane urea or TPU pellets.

11. Method according to claim 10, wherein step v) further comprises reaction with a monofunctional chain limiter.

12. Method according to claim 10, wherein the polyols are selected from the group comprising ethylene glycol, 1,4-butanediol, 1,3-propane diol, hydroquinone bis(2-hydroxyethyl)ether, isosorbide and isomers thereof, polyethers, polycaprolactones and polyols derived from fatty acids or vegetable oils.

13. Method according to claim 10, wherein the polyamines are selected from the group comprising 6-methyl-2,4-bis(methylthio)phenylene-1,3-diamine, 3,5-diethyltoluene-2,4-diamine, and 4,4-methylene bis(3-chloro-2,6-diethylaniline).

14. Method for preparing thermoplastic polyurethane pellets comprising the mixing of an isocyanate-terminated polyurethane prepolymer obtained according to the method of claim 1 with a chain extender having a functionality of 2 in an extruder coupled to an underwater pelletizer.
